(19) United States
(12) Patent Application Publication
(10) Pub. No.: US 2018/0154615 A1
(43) Pub. Date: Jun. 7, 2018

(54) GLASS LAMINATE WITH PANE HAVING GLASS-GLASS LAMINATE STRUCTURE

(71) Applicant: CORNING INCORPORATED, CORNING, NY (US)

(72) Inventors: Paul Bennett Dohn, Corning, NY (US); Viadislav Yuryevich Golyatin, Avon (FR); Butchi Reddy Vaddi, Painted Post, NY (US); Natesan Venkataraman, Painted Post, NY (US)

(21) Appl. No.: 15/578,128

(22) PCT Filed: Jun. 1, 2016
(86) PCT No.: PCT/US16/35151

§ 371 Date: Nov. 29, 2017

Related U.S. Application Data
(60) Provisional application No. 62/169,834, filed on Jun. 2, 2015.
(60) Provisional application No. 62/256,842, filed on Nov. 18, 2015.

(51) Int. Cl. B32B 17/10; B32B 37/08

(52) U.S. Cl. CPC B32B 17/10137; B32B 17/10036; B32B 17/10091; B32B 17/10247; B32B 2309/105; B32B 17/1077; B32B 17/10788; B32B 37/08; B32B 2605/006; B32B 17/10761

(57) ABSTRACT

A glass laminate includes a first pane having a glass-glass laminate structure, a second pane, and an interlayer disposed between the first pane and the second pane and including a polymeric material.

This application claims the benefit of priority to U.S. Application No. 62/169,834, filed Jun. 2, 2015, and U.S. Application No. 62/256,842, filed Nov. 18, 2015, the content of each of which is incorporated herein by reference in its entirety.

### BACKGROUND

### 1. Field

This disclosure relates to glass laminates, and more particularly to glass laminates comprising multiple panes at least one of which comprises a glass-glass laminate structure.

### 2. Technical Background

Glass laminates can be used as windows in architectural and vehicle or transportation applications, including automobiles, rolling stock, locomotives, and airplanes. Glass laminates also can be used as glass panels in balustrades and stairs, and as decorative panels or coverings for walls, columns, elevator cabs, kitchen appliances, and other applications. A glazing or a glass laminate can be a transparent, semi-transparent, translucent, or opaque part of a window, panel, wall, enclosure, sign or other structure. Common types of glazing that are used in architectural and/or vehicular applications include clear and tinted glass laminates.

Conventional automotive glazing constructions include two panes of 2 mm thick soda lime glass with a polyvinyl butyral (PVB) interlayer therebetween. These laminate constructions have certain advantages, including low cost and breakage performance that satisfies automotive requirements. However, because of their limited impact resistance, these laminates exhibit a relatively high probability of breakage when struck by roadside debris, vandals, or other objects of impact. Additionally, because of their relatively high weight, use of these laminates as automotive glazing results in lower vehicle fuel efficiency.

### SUMMARY

Disclosed herein are glass laminates comprising multiple panes at least one of which comprises a glass-glass laminate structure.

Disclosed herein is a glass laminate comprising a first pane comprising a glass-glass laminate structure, a second pane, and an interlayer disposed between the first pane and the second pane and comprising a polymeric material.

Also disclosed herein is a glass-glass laminate structure comprising a core layer, a first cladding layer adjacent to the core layer, and a second cladding layer adjacent to the core layer. The core layer is disposed between the first cladding layer and the second cladding layer. A pattern is formed on a surface of the glass-glass laminate and comprises an inorganic ink or enamel. Each of the first cladding layer and the second cladding layer comprises a compressive stress of about 10 MPa to about 800 MPa.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiment(s), and together with the description serve to explain principles and operation of the various embodiments.

### BRIEF DESCRIPTION OF THE DRAWINGS

FIG. 1 is a schematic cross-sectional view of one exemplary embodiment of a glass laminate comprising a pane comprising a glass-glass laminate structure.

FIG. 2 is a cross-sectional view of one exemplary embodiment of a forming apparatus for forming a glass-glass laminate structure.

FIG. 3 is a flow chart illustrating one exemplary process for forming a chemically strengthened glass sheet.

FIG. 4 is a perspective view of one exemplary embodiment of a glass laminate comprising a 3D shape.

FIG. 5 is a side view of one exemplary embodiment of an apparatus for performing a Stone Impact Test.

FIG. 6 is a front view of the apparatus of FIG. 5.

FIG. 7 is a graphical illustration of retained strength results for Examples 4A-4D and Comparative Examples 4E-4H.

FIG. 8 is a graphical illustration of retained strength results for Example 4J and Comparative Examples 4E and 41.

### DETAILED DESCRIPTION

Reference will now be made in detail to exemplary embodiments which are illustrated in the accompanying drawings. Whenever possible, the same reference numerals will be used throughout the drawings to refer to the same or like parts. The components in the drawings are not necessarily to scale, emphasis instead being placed upon illustrating the principles of the exemplary embodiments.

As used herein, the term “average coefficient of thermal expansion” refers to the average linear coefficient of thermal expansion of a given material or layer between 0° C. and 300° C. As used herein, the terms “coefficient of thermal expansion” and “CTE” refer to the average coefficient of thermal expansion unless otherwise indicated. The CTE can be determined, for example, using the procedure described in ASTM E228 “Standard Test Method for Linear Thermal Expansion of Solid Materials With a Push-Rod Dilatometer” or ISO 7991:1987 “Glass—Determination of coefficient of mean linear thermal expansion.”

In various embodiments, a glass laminate comprises at least a first pane, a second pane, and an interlayer disposed between the first pane and the second pane. The first pane and the second pane are laminated to each other with the interlayer. At least the first pane comprises a glass-glass laminate structure. The glass-glass laminate structure comprises at least a first glass layer and a second glass layer adjacent to the first glass layer. For example, the first glass layer comprises a core layer, and the second glass layer comprises a cladding layer adjacent to the core layer. In some embodiments, the cladding layer comprises a first cladding layer and a second cladding layer, and the core layer is disposed between the first cladding layer and the second cladding layer. Each of the first glass layer and the second glass layer comprises a glass material, a glass-ceramic material, or a combination thereof. In some embodiments, the first glass layer and/or the second glass layer are transparent glass layers. In some embodiments, the cladding layer has a different CTE than the core layer. Such a CTE mismatch between the cladding layer and the core layer can enable a strengthened glass-glass laminate structure with significant damage tolerance. The second pane comprises a glass sheet (e.g., a strengthened or non-strengthened glass sheet), a polymer sheet, or another suitable sheet material, or combinations thereof. In some embodiments, the second pane comprises a second glass-glass laminate structure that can be the same as or different than the glass-glass laminate structure of the first pane. The interlayer comprises a polymer material.

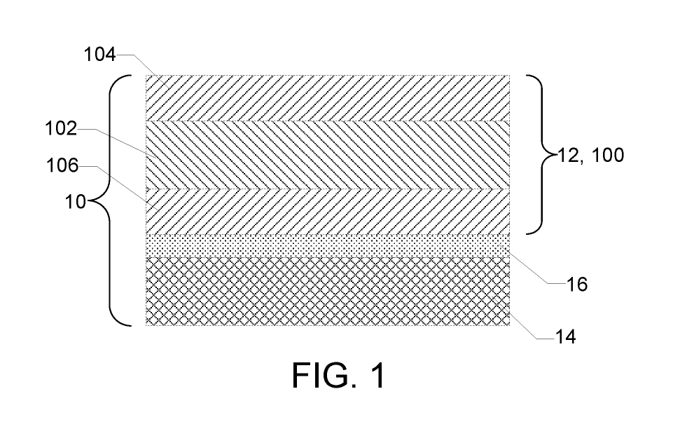

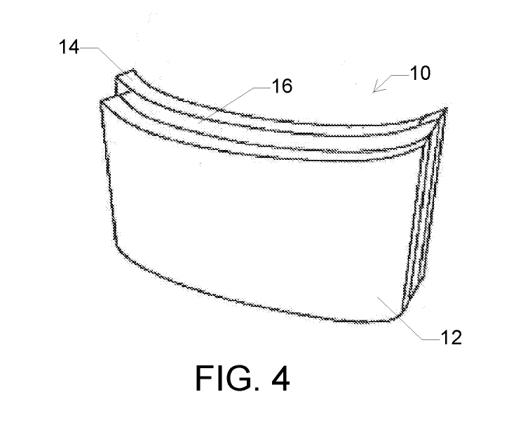

FIG. 1 is a schematic cross-sectional view of one exemplary embodiment of a glass laminate 10. In some embodiments, glass laminate 10 comprises a plurality of panes. Glass laminate 10 can be substantially planar as shown in FIG. 1 or non-planar (e.g., as described herein with reference to FIG. 4). Glass laminate 10 comprises a first pane 12, a second pane 14, and an interlayer 16 disposed between the first pane and the second pane. Thus, first pane 12 and second pane 14 are laminated to each other by interlayer 16.

At least one pane of the glass laminate comprises a glass-glass laminate structure comprising a plurality of glass layers. For example, in the embodiment shown in FIG. 1, first pane 12 comprises a glass-glass laminate structure 100. Another pane of the glass laminate can comprise a glass sheet, a polymer sheet, another suitable sheet material, or combinations thereof. For example, in the embodiment shown in FIG. 1, second pane 14 comprises a monolithic or single-layer glass sheet. The glass sheet comprises a chemically strengthened glass sheet, a thermally strengthened glass sheet, an annealed glass sheet, or another suitable glass sheet.

Interlayer 16 comprises a polymeric material such as, but not limited to, poly vinyl butyral (PVB), polycarbonate, acoustic PVB, ethylene vinyl acetate (EVA), thermoplastic polyurethane (TPU), ionomer, ionoplast, a cast in place (CIP) resin (e.g., based on an acrylic, a polyurethane, or a polyester), a thermoplastic material, another suitable polymeric material, or combinations thereof. For example, in the embodiment shown in FIG. 1, interlayer 16 comprises PVB.

Although second pane 14 of glass laminate 10 is described as comprising a monolithic or single-layer glass sheet, other embodiments are included in this disclosure. For example, in other embodiments, the second pane comprises a glass-glass laminate structure (e.g., a second glass-glass laminate structure). Thus, the glass laminate comprises two glass-glass laminate structures laminated to each other with the interlayer disposed therebetween. The glass-glass laminate structure of the first pane and the second glass-glass laminate structure of the second pane can be the same or different. For example, in some embodiments, the glass-glass laminate structure of the first pane can be configured for an exterior application (e.g., strong and/or chemically durable for an exterior surface of a vehicle or a building) and the second glass-glass laminate structure of the second pane can be configured for an interior application (e.g., breakable on impact for an interior surface of a vehicle or a building). Such a differential configuration can enable the glass laminate to resist breakage in response to impact on the exterior surface while maintaining its ability to break in response to impact on the interior surface (e.g., to comply with relevant automotive regulations). In other embodiments, the second pane comprises a polymer sheet. The polymer sheet comprises a polymeric material such as, but not limited to, polycarbonate, polyester, polypropylene, polyethylene, acrylic, another suitable polymeric material, or combinations thereof.

Returning to FIG. 1, first pane 12 of glass laminate 10 comprises glass-glass laminate structure 100. Glass-glass laminate structure 100 comprises a core layer 102 disposed between a first cladding layer 104 and a second cladding layer 106. In some embodiments, first cladding layer 104 and second cladding layer 106 are outer layers of glass-glass laminate structure 100 as shown in FIG. 1. In other embodiments, the first cladding layer and/or the second cladding layer are intermediate layers disposed between the core layer and an outer layer.

Core layer 102 comprises a first major surface and a second major surface opposite the first major surface. In some embodiments, first cladding layer 104 is fused to the first major surface of core layer 102. Additionally, or alternatively, second cladding layer 106 is fused to the second major surface of core layer 102. In such embodiments, the interfaces between first cladding layer 104 and core layer 102 and/or between second cladding layer 106 and core layer 102 are free of any bonding material such as, for example, an adhesive, a coating layer, or any non-glass material added or configured to adhere the respective cladding layers to the core layer. Thus, first cladding layer 104 and/or second cladding layer 106 are fused directly to core layer 102 or are directly adjacent to core layer 102. In some embodiments, the glass-glass laminate structure comprises one or more intermediate glass layers disposed between the core layer and the first cladding layer and/or between the core layer and the second cladding layer. For example, the intermediate glass layer comprises a diffusion layer formed at the interface of the core layer and the cladding layer. The diffusion layer can comprise a blended region comprising components of each layer adjacent to the diffusion layer. Thus, the directly adjacent glass layers are fused to each other at the diffusion layer. In some embodiments, the interfaces between directly adjacent glass layers are glass-glass interfaces.

In some embodiments, core layer 102 comprises a first glass composition, and first and/or second cladding layers 104 and 106 comprise a second glass composition that is different than the first glass composition. For example, in the embodiment shown in FIG. 1, core layer 102 comprises the first glass composition, and each of first cladding layer 104 and second cladding layer 106 comprises the second glass composition. In other embodiments, the first cladding layer comprises the second glass composition, and the second cladding layer comprises a third glass composition that is different than the first glass composition and/or the second glass composition.

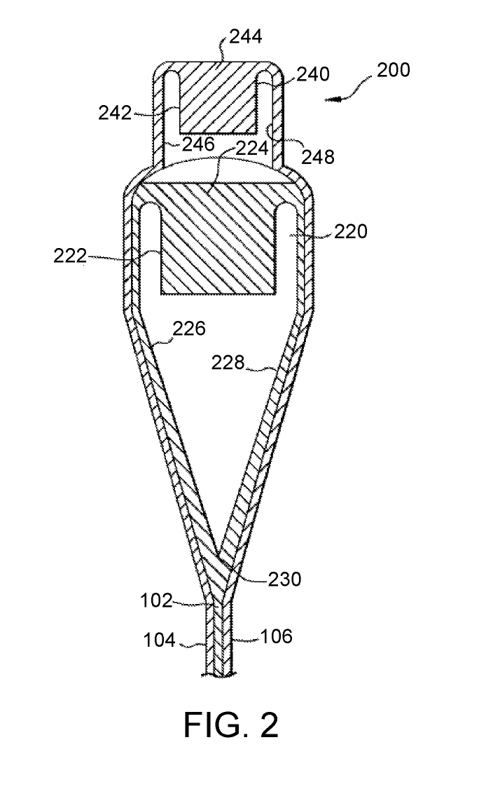

The glass-glass laminate structure can be formed using a suitable process such as, for example, a fusion draw, down draw, slot draw, up draw, or float process. The various layers of the glass-glass laminate structure can be laminated during forming of the glass-glass laminate structure or formed independently and subsequently laminated to form the glass-glass laminate structure. In some embodiments, the glass-glass laminate structure is formed using a fusion draw process. FIG. 2 is a cross-sectional view of one exemplary embodiment of an overflow distributor 200 that can be used to form a glass-glass laminate structure such as, for example, glass-glass laminate structure 100. Overflow distributor 200 can be configured as described in U.S. Pat. No. 4,214,886, which is incorporated herein by reference in its entirety. For example, overflow distributor 200 comprises a lower overflow distributor 220 and an upper overflow distributor 240 positioned above the lower overflow distributor. Lower overflow distributor 220 comprises a trough 222. A first glass composition 224 is melted and fed into trough 222 in a viscous state. First glass composition 224 forms core layer 102 of glass-glass laminate structure 100 as further described below. Upper overflow distributor 240 comprises a trough 242. A second glass composition 244 is melted and fed into trough 242 in a viscous state. Second glass composition 244 forms first and second cladding layers 104 and 106 of glass-glass laminate structure 100 as further described below.

First glass composition 224 overflows trough 222 and flows down opposing outer forming surfaces 226 and 228 of lower overflow distributor 220. Outer forming surfaces 226 and 228 converge at a draw line 230. The separate streams of first glass composition 224 flowing down respective outer forming surfaces 226 and 228 of lower overflow distributor 220 converge at draw line 230 where they are fused together to form core layer 102 of glass-glass laminate structure 100.

Second glass composition 244 overflows trough 242 and flows down opposing outer forming surfaces 246 and 248 of upper overflow distributor 240. Second glass composition 244 is deflected outward by upper overflow distributor 240 such that the second glass composition flows around lower overflow distributor 220 and contacts first glass composition 224 flowing over outer forming surfaces 226 and 228 of the lower overflow distributor. The separate streams of second glass composition 244 are fused to the respective separate streams of first glass composition 224 flowing down respective outer forming surfaces 226 and 228 of lower overflow distributor 220. Upon convergence of the streams of first glass composition 224 at draw line 230, second glass composition 244 forms first and second cladding layers 104 and 106 of glass-glass laminate structure 100.

In some embodiments, first glass composition 224 of core layer 102 in the viscous state is contacted with second glass composition 244 of first and second cladding layers 104 and 106 in the viscous state to form a glass-glass laminate sheet. In some of such embodiments, the glass-glass laminate sheet is part of a glass ribbon traveling away from draw line 230 of lower overflow distributor 220 as shown in FIG. 2. The glass ribbon can be drawn away from lower overflow distributor 220 by a suitable means including, for example, gravity and/or pulling rollers. The glass ribbon cools as it travels away from lower overflow distributor 220. The glass ribbon is severed to separate the glass-glass laminate sheet therefrom. Thus, the glass-glass laminate sheet is cut from the glass ribbon. The glass ribbon can be severed using a suitable technique such as, for example, scoring, bending, thermally shocking, and/or laser cutting. In some embodiments, glass-glass laminate structure 100 comprises the glass-glass laminate sheet as shown in FIG. 1. In other embodiments, the glass-glass laminate sheet can be processed further (e.g., by cutting or molding) to form glass-glass laminate structure 100.

Although glass-glass laminate structure 100 shown in FIG. 1 comprises three layers, other embodiments are included in this disclosure. In other embodiments, a glass-glass laminate structure can have a determined number of layers, such as two, four, or more layers. For example, a glass-glass laminate structure comprising two layers can be formed using two overflow distributors positioned so that the two layers are joined while traveling away from the respective draw lines of the overflow distributors or using a single overflow distributor with a divided trough so that two glass compositions flow over opposing outer forming surfaces of the overflow distributor and converge at the draw line of the overflow distributor. A glass-glass laminate structure comprising four or more layers can be formed using additional overflow distributors and/or using overflow distributors with divided troughs. Thus, a glass-glass laminate structure having a determined number of layers can be formed by modifying the overflow distributor accordingly.

In some embodiments, glass-glass laminate structure 100 comprises a thickness of at least about 0.05 mm, at least about 0.1 mm, at least about 0.2 mm, or at least about 0.3 mm. Additionally, or alternatively, glass-glass laminate structure 100 comprises a thickness of at most about 3 mm, at most about 2 mm, at most about 1.5 mm, at most about 1 mm, at most about 0.7 mm, or at most about 0.5 mm. In some embodiments, a ratio of a thickness of core layer 102 to a thickness of glass-glass laminate structure 100 is at least about 0.6, at least about 0.7, at least about 0.8, at least about 0.85, at least about 0.9, or at least about 0.95. In some embodiments, a thickness of the second layer (e.g., each of first cladding layer 104 and second cladding layer 106) is from about 0.01 mm to about 0.3 mm.

In some embodiments, the first glass composition and/or the second glass composition comprise a liquidus viscosity suitable for forming glass-glass laminate structure 100 using a fusion draw process as described herein. For example, the first glass composition of the first layer (e.g., core layer 102) comprises a liquidus viscosity of at least about 100 kiloPoise (kP), at least about 200 kP, or at least about 300 kP. Additionally, or alternatively, the first glass composition comprises a liquidus viscosity of at most about 3000 kP, at most about 2500 kP, at most about 1000 kP, or at most about 800 kP. Additionally, or alternatively, the second glass composition of the second layer (e.g., first and/or second cladding layers 104 and 106) comprises a liquidus viscosity of at least about 50 kP, at least about 100 kP, or at least about 200 kP. Additionally, or alternatively, the second glass composition comprises a liquidus viscosity of at most about 3000 kP, at most about 2500 kP, at most about 1000 kP, or at most about 800 kP. The first glass composition can aid in carrying the second glass composition over the overflow distributor to form the second layer. Thus, the second glass composition can comprise a liquidus viscosity that is lower than generally considered suitable for forming a single layer sheet using a fusion draw process.

In some embodiments, glass-glass laminate structure 100 is configured as a strengthened glass-glass laminate structure. For example, in some embodiments, the second glass composition of the second layer (e.g., first and/or second cladding layers 104 and 106) comprises a different average coefficient of thermal expansion (CTE) than the first glass composition of the first layer (e.g., core layer 102). For example, first and second cladding layers 104 and 106 are formed from a glass composition having a lower average CTE than core layer 102. The CTE mismatch (i.e., the difference between the average CTE of first and second cladding layers 104 and 106 and the average CTE of core layer 102) results in formation of compressive stress in the cladding layers and tensile stress in the core layer upon cooling of glass-glass laminate structure 100. Such strengthening caused by CTE mismatch between adjacent glass layers can be referred to as mechanical strengthening. Thus, the strengthened glass-glass laminate structure can be referred to as a mechanically strengthened glass sheet. In various embodiments, each of the first and second cladding layers, independently, can have a higher average CTE, a lower average CTE, or substantially the same average CTE as the core layer.

In some embodiments, the average CTE of the first layer (e.g., core layer 102) and the average CTE of the second layer (e.g., first and/or second cladding layers 104 and 106) differ by at least about 5×10⁻⁷° C.⁻¹, at least about 15×10⁻⁷° C.⁻¹, or at least about 25×10⁻⁷° C.⁻¹. Additionally, or alternatively, the average CTE of the first layer and the average CTE of the second layer differ by at most about 55×10⁻⁷° C.⁻¹, at most about 50×10⁻⁷° C.⁻¹, at most about 40×10⁻⁷° C.⁻¹, at most about 30×10⁻⁷° C.⁻¹, at most about 20×10⁻⁷° C.⁻¹, or at most about 10×10⁷° C.⁻¹. For example, in some embodiments, the average CTE of the first layer and the average CTE of the second layer differ by from about 5×10⁻⁷° C.⁻¹ to about 30×10⁻⁷° C.⁻¹ or from about 5×10⁻⁷° C.⁻¹ to about 20×10⁻⁷° C.⁻¹. In some embodiments, the second glass composition of the second layer comprises an average CTE of at most about 40×10⁻⁷° C.⁻¹, or at most about 35×10⁻⁷° C.⁻¹. Additionally, or alternatively, the second glass composition of the second layer comprises an average CTE of at least about 25×10⁻⁷° C.⁻¹, or at least about 30×10⁻⁷° C.⁻¹. Additionally, or alternatively, the first glass composition of the first layer comprises an average CTE of at least about 40×10⁻⁷° C.⁻¹, at least about 50×10⁻⁷° C.⁻¹, or at least about 55×10⁷° C.⁻¹. Additionally, or alternatively, the first glass composition of the first layer comprises an average CTE of at most about 90×10⁻⁷° C.⁻¹, at most about 85×10⁻⁷° C.⁻¹, at most about 80×10⁻⁷° C.⁻¹, at most about 70×10⁻⁷° C.⁻¹, or at most about 60×10⁻⁷° C.⁻¹.

In some embodiments, the compressive stress of the cladding layers is at most about 800 MPa, at most about 500 MPa, at most about 300 MPa, at most about 200 MPa, at most about 150 MPa, at most about 100 MPa, at most about 50 MPa, or at most about 40 MPa. Additionally, or alternatively, the compressive stress of the cladding layers is at least about 10 MPa, at least about 20 MPa, at least about 30 MPa, at least about 50 MPa, at least about 100 MPa, or at least about 200 MPa.

The first glass composition of the first layer (e.g., core layer 102) and the second glass composition of the second layer (e.g., first cladding layer 104 and/or second cladding layer 106) can comprise suitable glass compositions capable of forming a glass-glass laminate structure with desired properties as described herein.

In some embodiments, the glass compositions are capable of forming a glass-glass laminate structure suitable for forming into a 3-dimensional (3D) shape using conventional forming equipment (e.g., sagging or other molding equipment designed for use with soda lime glass). Examples of glass-glass laminate structures suitable for 3D forming are described in International Patent Application Nos. PCT/US2015/029671 and PCT/US2015/029681, each of which is incorporated herein by reference in its entirety. For example, the glass-glass laminate structure comprises an effective 10⁹⁹ Poise (P) temperature of at most about 750° C., at most about 725° C., at most about 700° C., or at most about 675° C. The effective 10^{9.9} P temperature T_{9.9P,eff} of glass-glass laminate structure 100 comprises a thickness weighted average 10^{9.9} P temperature of the glass-glass laminate structure. For example, in some embodiments, core layer 102 comprises a thickness t_{core}, and each of first cladding layer 104 and second cladding layer 106 comprises a thickness t_{clad}. The first glass composition comprises a 10^{9.9} P temperature T_{9.9P,core}, and the second glass composition comprises a 10^{9.9} P temperature T_{9.9P,clad}. Thus, the effective 10^{9.9} P temperature of glass-glass laminate structure 100 is represented by equation 1.

$${T}_{9.9 P , eff} = \frac{{t}_{core} {T}_{9.9 P , core} + 2 {t}_{clad} {T}_{9.9 P , clad}}{{t}_{core} + 2 {t}_{clad}} \qquad ( 1 )$$

Additionally, or alternatively, the second layer comprises a higher 10⁹⁹ P temperature than the first layer. Thus, the viscosity of the second layer is higher than the viscosity of the first layer during forming of the glass-glass laminate structure into a 3D shape. Such a differential in 10⁹⁹ P temperature can enable the glass-glass laminate structure to be formed into a 3D shape at a relatively low forming temperature while reducing interactions between the glass-glass laminate structure and the forming equipment (e.g., because of the higher viscosity of the cladding layers in contact with the forming equipment).

In some embodiments, the glass compositions are capable of forming a glass-glass laminate structure suitable for use in outdoor applications (e.g., automotive or architectural applications). For example, the second layer comprises chemical durability similar to that of soda lime glass. The chemical durability of a glass composition can be represented by a degradation rate of the glass composition in response to exposure to a reagent at a particular temperature for a particular period of time. The degradation rate can be expressed, for example, as mass of the sample lost per surface area of the sample. In some embodiments, the chemical durability is determined using the following procedure, which is referred to herein as the “durability test”. A sample having the glass-glass laminate structure with a width of about 2.5 cm and a length of about 2.5 cm is soaked in Opticlear at 40° C. and rinsed with IPA. The sample is wiped with cheese cloth while rinsing with deionized water and then dried at 140° C. for at least 30 minutes. 200 mL of the reagent solution is added to a preleached 250 ml FEP bottle and preheated for about 1-2 hours in an oven set at 95° C. The glass sample is leaned upright against the side wall of the bottle and allowed to soak for a determined time at a determined temperature. About 15 mL of the resulting solution is poured into a centrifuge tube and reserved for ICP. The remainder of the solution is disposed of and the sample, still remaining in the bottle, is immediately quenched in deionized water. After quenching, the sample is retrieved from the bottle, rinsed in deionized water, and dried at 140° C. for at least 30 minutes. The weight loss of the sample is measured and the chemical durability is determined as weight loss per unit surface area. In some embodiments, a degradation rate of the second glass composition in response to exposure to a 5 vol % aqueous HCl solution at 95° C. for 6 h is at most about 0.018 mg/cm², at most about 0.009 mg/cm², or at most about 0.005 mg/cm². Additionally, or alternatively, a degradation rate of the second glass composition in response to exposure to a 1 M aqueous HNO₃ solution at 95° C. for 24 h is at most about 0.08 mg/cm², at most about 0.06 mg/cm², or at most about 0.03 mg/cm². Additionally, or alternatively, a degradation rate of the second glass composition in response to exposure to a 0.02 N aqueous H₂SO₄ solution at 95° C. for 24 h is at most about 0.04 mg/cm², at most about 0.02 mg/cm², or at most about 0.005 mg/cm². In other embodiments, chemical durability of a glass composition is determined as described in ANSI Z26.1, Test 19; RECE R43, Test A3/6; ISO 695; ISO 720; DIN 12116; each of which is incorporated by reference herein in its entirety; or a similar standard.

In some embodiments, the first glass composition of the first layer of the glass-glass laminate structure comprises a glass network former selected from the group consisting of SiO₂, Al₂O₃, B₂O₃, P₂O₅, and combinations thereof. For example, the first glass composition comprises at least about 45 mol % SiO₂, at least about 50 mol % SiO₂, at least about 60 mol % SiO₂, at least about 70 mol % SiO₂, or at least about 75 mol % SiO₂. Additionally, or alternatively, the first glass composition comprises at most about 80 mol % SiO₂, at most about 75 mol % SiO₂, at most about 60 mol % SiO₂, or at most about 50 mol % SiO₂. Additionally, or alternatively, the first glass composition comprises at least about 5 mol % Al₂O₃, at least about 9 mol % Al₂O₃, at least about 15 mol % Al₂O₃, or at least about 20 mol % Al₂O₃. Additionally, or alternatively, the first glass composition comprises at most about 25 mol % Al₂O₃, at most about 20 mol % Al₂O₃, at most about 15 mol % Al₂O₃, or at most about 10 mol % Al₂O₃. Additionally, or alternatively, the first glass composition comprises at least about 1 mol % B₂O₃, at least about 4 mol % B₂O₃, or at least about 7 mol % B₂O₃. Additionally, or alternatively, the first glass composition comprises at most about 10 mol % B₂O₃, at most about 8 mol % B₂O₃, or at most about 5 mol % B₂O₃. Additionally, or alternatively, the first glass composition comprises at least about 2 mol % P₂O₅. Additionally, or alternatively, the first glass composition comprises at most about 5 mol % P₂O₅.

In some embodiments, the first glass composition comprises an alkali metal oxide selected from the group consisting of Li₂O, Na₂O, K₂O, and combinations thereof. For example, the first glass composition comprises at least about 5 mol % Na₂O, at least about 9 mol % Na₂O, or at least about 12 mol % Na₂O. Additionally, or alternatively, the first glass composition comprises at most about 20 mol % Na₂O, at most about 16 mol % Na₂O, or at most about 13 mol % Na₂O. Additionally, or alternatively, the first glass composition comprises at least about 0.01 mol % K₂O, at least about 1 mol % K₂O, at least about 2 mol % K₂O, or at least about 3 mol % K₂O. Additionally, or alternatively, the first glass composition comprises at most about 5 mol % K₂O, at most about 4 mol % K₂O, at most about 3 mol % K₂O, or at most about 1 mol % K₂O.

In some embodiments, the first glass composition comprises an alkaline earth oxide selected from the group consisting of MgO, CaO, SrO, BaO, and combinations thereof.

In some embodiments, the first glass composition comprises one or more additional components including, for example SnO₂, Sb₂O₃, As₂O₃, Ce₂O₃, Cl (e.g., derived from KCl or NaCl), ZrO₂, or Fe₂O₃.

In some embodiments, the second glass composition of the second layer of the glass-glass laminate structure comprises a glass network former selected from the group consisting of SiO₂, Al₂O₃, B₂O₃, and combinations thereof. For example, the second glass composition comprises at least about 65 mol % SiO₂, at least about 68 mol % SiO₂, at least about 70 mol % SiO₂, or at least about 75 mol % SiO₂. Additionally, or alternatively, the second glass composition comprises at most about 80 mol % SiO₂, at most about 77 mol % SiO₂, at most about 75 mol % SiO₂, or at most about 70 mol % SiO₂. Additionally, or alternatively, the second glass composition comprises at least about 1 mol % Al₂O₃, at least about 5 mol % Al₂O₃, or at least about 9 mol % Al₂O₃. Additionally, or alternatively, the second glass composition comprises at most about 15 mol % Al₂O₃, at most about 11 mol % Al₂O₃, at most about 5 mol % Al₂O₃, or at most about 3 mol % Al₂O₃. Additionally, or alternatively, the second glass composition comprises at least about 1 mol % B₂O₃, at least about 5 mol % B₂O₃, or at least about 9 mol % B₂O₃. Additionally, or alternatively, the second glass composition comprises at most about 20 mol % B₂O₃, at most about 16 mol % B₂O₃, or at most about 10 mol % B₂O₃.

In some embodiments, the second glass composition comprises an alkali metal oxide selected from the group consisting of Li₂O, Na₂O, K₂O, and combinations thereof. For example, the second glass composition comprises at least about 1 mol % Na₂O, or at least about 2 mol % Na₂O. Additionally, or alternatively, the second glass composition comprises at most about 15 mol % Na₂O, at most about 11 mol % Na₂O, or at most about 5 mol % Na₂O. Additionally, or alternatively, the second glass composition comprises from about 0.1 mol % to about 6 mol % K₂O, or from about 0.1 mol % to about 1 mol % K₂O. In some embodiments, the second glass composition is substantially free of alkali metal. For example, the second glass composition comprises at most about 0.01 mol % alkali metal oxide. In other embodiments, the second glass composition comprises from about 2 mol % to about 15 mol % alkali metal oxide.

In some embodiments, the second glass composition comprises an alkaline earth oxide selected from the group consisting of MgO, CaO, SrO, BaO, and combinations thereof. For example, the second glass composition comprises at least about 0.1 mol % MgO, at least about 1 mol % MgO, at least about 3 mol % MgO, at least about 5 mol % MgO, or at least about 10 mol % MgO. Additionally, or alternatively, the second glass composition comprises at most about 15 mol % MgO, at most about 10 mol % MgO, at most about 5 mol % MgO, or at most about 1 mol % MgO. Additionally, or alternatively, the second glass composition comprises at least about 0.1 mol % CaO, at least about 1 mol % CaO, at least about 3 mol % CaO, at least about 5 mol % CaO, or at least about 7 mol % CaO. Additionally, or alternatively, the second glass composition comprises at most about 10 mol % CaO, at most about 7 mol % CaO, at most about 5 mol % CaO, at most about 3 mol % CaO, or at most about 1 mol % CaO. In some embodiments, the second glass composition comprises from about 1 mol % to about 25 mol % alkaline earth oxide.

In some embodiments, the second glass composition comprises one or more additional components including, for example SnO₂, Sb₂O₃, As₂O₃, Ce₂O₃, CI (e.g., derived from KCl or NaCl), ZrO₂, or Fe₂O₃.

Examples of glass compositions that can be suitable for use as one or more layers of the glass-glass laminate structure are described in International Patent Application Nos. PCT/US2015/029671 and PCT/US2015/029681, each of which is incorporated herein by reference in its entirety. Exemplary glass compositions also are shown in Table 1. The amounts of the various components are given in Table 1 as mol % on an oxide basis.

TABLE 1
Exemplary Glass Compositions

| | 1 | 2 | 3 | 4 | 5 | 6 | 7 |
|---|---|---|---|---|---|---|---|
| SiO₂ | 76.33 | 72.12 | 54.03 | 45.61 | 60.53 | 52.83 | 73.7 |
| Al₂O₃ | 7.17 | 9.15 | 15.92 | 21.37 | 12.35 | 17.01 | 6.83 |
| B₂O₃ | 4.05 | 4.16 | 8.13 | 7.07 | 1.99 | 5.2 | |
| P₂O₅ | | | 3.18 | 4.92 | 0.0244 | 2.517 | |
| Na₂O | 12.18 | 9.88 | 14.7 | 15.73 | 13.94 | 14.839 | 12.01 |
| K₂O | 0.01 | 2.53 | 3.62 | 0.006 | 3.67 | 1.752 | 2.74 |
| MgO | 0.01 | 0.03 | 0.0033 | 0.0055 | 0.6046 | 0.31 | 4.52 |
| CaO | 0.04 | 0.02 | 0.018 | 0.0246 | 0.0221 | 0.03 | |
| BaO | | | | 0.0013 | 0.0041 | | |
| ZnO | | 1.9 | 0.002 | 4.64 | 6.14 | 5.403 | |
| SnO₂ | 0.2 | 0.2 | 0.0367 | 0.3208 | 0.1453 | 0.308 | 0.19 |
| ZrO₂ | | | 0.0544 | 0.0334 | 0.0267 | 0.026 | |
| CeO₂ | | | 0.2179 | | | | |
| MnO₂ | | | 0.0003 | | | | |
| TiO₂ | | | 0.0085 | | 0.0035 | | |
| Fe₂O₃ | | | 0.0089 | 0.0081 | 0.009 | 0.008 | |
| Sb₂O₃ | | | 0.002 | 0.0782 | 0.0666 | 0.072 | |

| | 8 | 9 | 10 | 11 | 12 | 13 | 14 |
|---|---|---|---|---|---|---|---|
| SiO₂ | 78.67 | 77.9 | 77.4 | 77 | 76.6 | 77 | 77 |
| Al₂O₃ | 1.95 | 3.42 | 7 | 7 | 7 | 7 | 7 |
| B₂O₃ | 14.19 | 9.82 | | | | | |
| P₂O₅ | | | | | | | |
| Na₂O | 3.64 | 7.01 | 10 | 10.2 | 10.4 | 5.3 | 10.4 |
| K₂O | 0.01 | | 0.1 | 0.3 | 0.5 | 5.2 | 0.1 |
| MgO | 0.02 | 0.09 | 4.8 | 4.8 | 4.8 | 4.8 | 2.8 |
| CaO | 0.85 | 1.64 | 0.5 | 0.5 | 0.5 | 0.5 | 2.5 |
| BaO | 0.58 | | | | | | |
| ZnO | | | | | | | |
| SnO₂ | 0.07 | | 0.2 | 0.2 | 0.2 | 0.2 | 0.2 |
| ZrO₂ | | | | | | | |
| CeO₂ | | | | | | | |
| MnO₂ | | | | | | | |
| TiO₂ | | | | | | | |
| Fe₂O₃ | | | | | | | |
| Sb₂O₃ | | | | | | | |
| | 15 | 16 | 17 | 18 | 19 | 20 | 21 |
| SiO₂ | 77 | 77 | 77 | 77 | 76.5 | 76.5 | 75 |
| Al₂O₃ | 6.5 | 6.5 | 6.5 | 6.5 | 6.5 | 6.5 | 8 |
| B₂O₃ | | | | | | | |
| P₂O₅ | | | | | | | |
| Na₂O | 10.7 | 11 | 10.4 | 9.8 | 8 | 7 | 6 |
| K₂O | 0.1 | 0.1 | 0.1 | 0.1 | 0.1 | 0.1 | 0.1 |
| MgO | 2.5 | 2.7 | 3 | 3.3 | 4.5 | 5 | 5.5 |
| CaO | 3 | 2.5 | 2.8 | 3.1 | 4.2 | 4.7 | 5.2 |
| BaO | | | | | | | |
| ZnO | | | | | | | |
| SnO₂ | 0.2 | 0.2 | 0.2 | 0.2 | 0.2 | 0.2 | 0.2 |
| ZrO₂ | | | | | | | |
| CeO₂ | | | | | | | |
| MnO₂ | | | | | | | |
| TiO₂ | | | | | | | |
| Fe₂O₃ | | | | | | | |
| Sb₂O₃ | | | | | | | |
| | 22 | 23 | 24 | 25 | 26 | 27 | 28 |
| SiO₂ | 70 | 72 | 68 | 70 | 72 | 68 | 70 |
| Al₂O₃ | 11 | 9 | 11 | 9 | 7 | 9 | 9 |
| B₂O₃ | | | | | | | |
| P₂O₅ | | | | | | | |
| Na₂O | 5 | 5 | 5 | 5 | 5 | 5 | 3 |
| K₂O | | | | | | | |
| MgO | 7 | 7 | 7 | 7 | 7 | 13 | 13 |
| CaO | 7 | 7 | 9 | 9 | 9 | 5 | 5 |
| BaO | | | | | | | |
| ZnO | | | | | | | |
| SnO₂ | 0.2 | 0.2 | 0.2 | 0.2 | 0.2 | 0.2 | 0.2 |
| ZrO₂ | | | | | | | |
| CeO₂ | | | | | | | |
| MnO₂ | | | | | | | |
| TiO₂ | | | | | | | |
| Fe₂O₃ | | | | | | | |
| Sb₂O₃ | | | | | | | |
| | 29 | 30 | 31 | 32 | 33 | 34 | 35 |
| SiO₂ | 72 | 68 | 70 | 72 | 68 | 68 | 70 |
| Al₂O₃ | 7 | 9 | 7 | 11 | 7 | 9 | 7 |
| B₂O₃ | | | | | | | |
| P₂O₅ | | | | | | | |
| Na₂O | 3 | 3 | 3 | 5 | 3 | 1 | 1 |
| K₂O | | | | | | | |
| MgO | 13 | 13 | 13 | 7 | 13 | 13 | 13 |
| CaO | 5 | 7 | 7 | 5 | 9 | 9 | 9 |
| BaO | | | | | | | |
| ZnO | | | | | | | |
| SnO₂ | 0.2 | 0.2 | 0.2 | 0.2 | 0.2 | 0.2 | 0.2 |
| ZrO₂ | | | | | | | |
| CeO₂ | | | | | | | |
| MnO₂ | | | | | | | |
| TiO₂ | | | | | | | |
| Fe₂O₃ | | | | | | | |
| Sb₂O₃ | | | | | | | |
| | 36 | 37 | 38 | 39 | 40 | 41 | 42 |
| SiO₂ | 72 | 70 | 72 | 68 | 72 | 70 | 72 |
| Al₂O₃ | 11 | 11 | 9 | 11 | 11 | 11 | 9 |
| B₂O₃ | | | | | | | |
| P₂O₅ | | | | | | | |
| Na₂O | 3 | 3 | 3 | 3 | 1 | 1 | 1 |
| K₂O | | | | | | | |
| MgO | 7 | 7 | 7 | 13 | 7 | 13 | 13 |
| CaO | 7 | 9 | 9 | 5 | 9 | 5 | 5 |
| BaO | | | | | | | |
| ZnO | | | | | | | |
| SnO₂ | 0.2 | 0.2 | 0.2 | 0.2 | 0.2 | 0.2 | 0.2 |
| ZrO₂ | | | | | | | |
| CeO₂ | | | | | | | |
| MnO₂ | | | | | | | |
| TiO₂ | | | | | | | |
| Fe₂O₃ | | | | | | | |
| Sb₂O₃ | | | | | | | |

| | 43 | 44 | 45 |
|---|---|---|---|
| SiO₂ | 68 | 70 | 72 |
| Al₂O₃ | 11 | 9 | 7 |
| B₂O₃ | | | |
| P₂O₅ | | | |
| Na₂O | 1 | 1 | 1 |
| K₂O | | | |
| MgO | 13 | 13 | 13 |
| CaO | 7 | 7 | 7 |
| BaO | | | |
| ZnO | | | |
| SnO₂ | 0.2 | 0.2 | 0.2 |
| ZrO₂ | | | |
| CeO₂ | | | |
| MnO₂ | | | |
| TiO₂ | | | |
| Fe₂O₃ | | | |
| Sb₂O₃ | | | |

In some embodiments, glass-glass laminate structure 100 comprises a pattern (e.g., a decorative pattern) formed on a surface thereof. For example, the pattern comprises a substantially solid color, a design (e.g., one or more lines, textures, or shapes), or a combination thereof. For example, the pattern comprises a decorative edging for a vehicle windshield, a defroster grid for a vehicle backlite, an antenna, a textured pattern for a vehicle interior or exterior panel, or another pattern. In some embodiments, glass-glass laminate structure 100 comprises an inorganic ink or enamel printed on a surface thereof to form the pattern. For example, the inorganic ink or enamel comprises a frit material. Glass-glass laminate structure 100 can be heated (e.g., to sinter or fire the inorganic ink or enamel and/or to form the glass-glass laminate structure into a 3D shape as described herein) after the pattern is printed thereon. In some embodiments, the pattern is printed on the glass-glass laminate structure in a substantially planar configuration, and the glass-glass laminate structure is formed into a 3D shape after the pattern is printed thereon. Because the glass-glass laminate structure is substantially flat during printing, conventional printing processes (e.g., screen printing, flexographic printing, gravure printing, photo pattern printing, pad printing, inkjet printing, another suitable printing process, or combinations thereof) can be used to print the pattern. Because the glass-glass laminate structure is mechanically strengthened, as opposed to being thermally strengthened or chemically strengthened, such heating does not substantially affect the compressive stress of the glass-glass laminate structure. For example, the compressive stress, the depth of compressive layer, and the central tension of the glass-glass laminate structure is substantially the same before and after heating. Thus, the glass-glass laminate structure can enable a strengthened glass sheet with a pattern formed thereon using inorganic ink or enamel. Such a decorated laminate can be used alone as a glass sheet or as part of a glass laminate as described herein. In some embodiments, the printed pattern is disposed on an internal surface (e.g., adjacent to the interlayer) of the glass-glass laminate structure. Thus, the printed pattern is embedded within the glass laminate, which may protect the printed pattern from damage. In other embodiments, the printed pattern is disposed on an external surface (e.g., remote from the interlayer) of the glass-glass laminate structure.

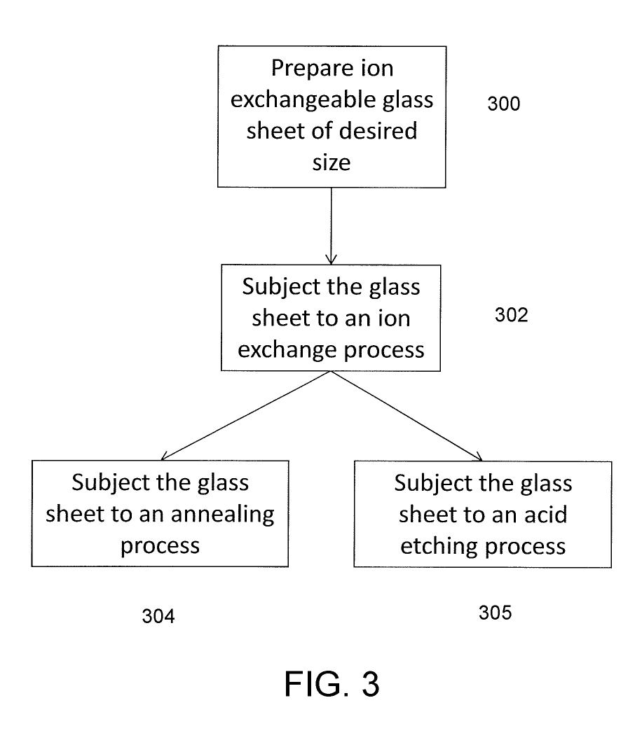

Returning to FIG. 1, second pane 14 of glass laminate 10 comprises a glass sheet. For example, in some embodiments, second pane 14 comprises a chemically strengthened glass sheet. The chemically strengthened glass sheet can be formed using a suitable chemical strengthening process. The chemically strengthened glass sheet can be relatively thin (e.g., about 2 mm or less) and can have one or more characteristics such as compressive stress (CS), relatively high depth of compressive layer (DOL), and/or moderate central tension (CT). FIG. 3 is a flow diagram illustrating an exemplary process for forming a chemically strengthened glass sheet such as, for example, second pane 14. The process can be performed as described in International Patent Application Pub. No. 2015/031594, which is incorporated herein by reference in its entirety. For example, in some embodiments, the process comprises preparing a glass sheet capable of ion exchange (step 300). The glass sheet is subjected to an ion exchange process (step 302) to form the chemically strengthened glass sheet. In some embodiments, the chemically strengthened glass sheet is further subjected to an annealing process (step 304), an acid etching process (step 305), or both.

CS and DOL can be determined, for example, by surface stress meter (FSM) using commercially available instruments such as the FSM-6000, manufactured by Luceo Co., Ltd. (Tokyo, Japan), or the like. Methods of measuring CS and DOL are described, for example, in ASTM C1422/C1422M “Standard Specification for Chemically Strengthened Flat Glass,” ASTM 1279.19779 “Standard Test Method for Non-Destructive Photoelastic Measurement of Edge and Surface Stresses in Annealed, Heat-Strengthened, and Fully-Tempered Flat Glass,” and ASTM F218 “Standard Method for Analyzing Stress in Glass,” which are incorporated herein by reference in their entirety. Surface stress measurements rely upon the accurate measurement of the stress optical coefficient (SOC), which is related to the birefringence of the glass. SOC in turn is measured by those methods that are known in the art, such as fiber and four point bend methods, both of which are described in ASTM C770-98 (2008) “Standard Test Method for Measurement of Glass Stress-Optical Coefficient,” which is incorporated herein by reference in its entirety, and a bulk cylinder method. Other techniques for measuring CS and DOL include, for example, those described in U.S. Pat. Nos. 8,957,374 and 9,140,543, which are incorporated herein by reference in their entirety.

In some embodiments, subjecting the glass sheet to the ion exchange process (step 302) comprises contacting the glass sheet with a molten salt (e.g., by submerging the glass sheet in a molten salt bath including KNO₃, such as relatively pure KNO₃) at one or more first temperatures within the range of about 400° C. to about 500° C. and/or for a first time period within the range of about 1 hour to about 24 hours, such as, but not limited to, about 8 hours. Such an exemplary ion exchange process can produce a chemically strengthened glass sheet having an initial compressive stress (iCS) at the surface of the glass sheet, an initial depth of compressive layer (iDOL) into the glass sheet, and an initial central tension (iCT) within the glass sheet.

In some embodiments, iCS is at least about 500 MPa, at least about 600 MPa, or at least about 1000 MPa. In some embodiments, iCS exceeds a predetermined (or desired) value. Thus, it can be beneficial to reduce the compressive stress of the glass sheet from iCS for some applications. Additionally, or alternatively, iDOL is at most about 75 μm. Additionally, or alternatively, iCT is at least about 40 MPa or at least about 48 MPa. In some embodiments, iCT exceeds a predetermined (or desired) value, such as a predetermined frangibility limit of the glass sheet. Thus, it can be beneficial to reduce the central tension of the glass sheet from iCT for some applications.

If iCS exceeds a predetermined value, iDOL is below a predetermined value, and/or iCT exceeds a predetermined value, the glass laminate comprising the glass sheet can exhibit undesirable characteristics. For example, if iCS exceeds a predetermined value (e.g., 1000 MPa), then the glass sheet may not fracture under certain circumstances in which fracture is desirable. For example, it can be beneficial for the glass sheet to break under certain conditions, such as in an automotive glass application where the glass laminate or a portion thereof should break at a certain impact load to prevent injury.

If iDOL is below a predetermined value, the glass sheet can break unexpectedly and/or under undesirable circumstances. In some embodiments, iDOL is less than the depth of scratches, pits, etc., that develop in the glass sheet during use (e.g., less than about 60 μm or less than about 40 μm). For example, it has been discovered that installed automotive glazing (using ion exchanged glass) can develop external scratches reaching as deep as about 75 μm or more. Such scratches can result from exposure of the automotive glazing to abrasive materials (e.g., silica sand, flying debris, etc.) within the environment in which the automotive glazing is used. The depth of such scratches can exceed iDOL, which can lead to the glass sheet unexpectedly fracturing during use.

If iCT exceeds a predetermined value (e.g., the frangibility limit of the glass sheet), the glass sheet can break unexpectedly and/or under undesirable circumstances. For example, it has been discovered that a 4 inch×4 inch×0.7 mm sheet of Corning Gorilla® Glass exhibits performance characteristics in which undesirable fragmentation (energetic failure into a large number of small pieces when broken) occurs when a long, single step ion exchange process (8 hours at 475° C.) is performed in pure KNO₃. Although a DOL of about 101 μm is achieved in such an ion exchange process, a relatively high CT of 65 MPa results, which is higher than the frangibility limit of the subject glass sheet (48 MPa).

In embodiments in which annealing is performed after the glass sheet has been subjected to ion exchange, the chemically strengthened glass sheet can be subjected to an annealing process (step 304) by heating the chemically strengthened glass sheet to one or more second temperatures for a second period of time. For example, the annealing process 304 can be carried out in an air environment, can be performed at second temperatures within the range of about 400° C. to about 500° C., and can be performed for a second time period within the range of about 4 hours to about 24 hours, such as, but not limited to, about 8 hours. The annealing process 304 can cause at least one of the compressive stress, the depth of compressive layer, or the central tension of the chemically strengthened glass sheet to be modified from the initial value.

For example, after the annealing process 304, the compressive stress of the chemically strengthened glass sheet can be reduced from iCS to a final compressive stress (fCS) that is at or below a predetermined value. By way of example, iCS can be at least about 500 MPa, and fCS can be at most about 400 MPa, at most about 350 MPa, or at most about 300 MPa. It is noted that the target for fCS can depend on glass thickness. For example, for a thicker chemically strengthened glass sheet, a lower fCS can be desirable. Conversely, for a thinner chemically strengthened glass sheet, a higher fCS can be tolerable.

Additionally, or alternatively, after the annealing process 304, the depth of compressive layer of the chemically strengthened glass sheet can be increased from iDOL to a final depth of compressive layer (fDOL) that is at or above a predetermined value. By way of example, iDOL can be at most about 75 μm, and fDOL can be at least about 80 μm, at least about 90 μm, or at least about 100 μm.

Additionally, or alternatively, after the annealing process 304, the central tension of the chemically strengthened glass sheet can be reduced from iCT to a final central tension (fCT) at or below a predetermined value. By way of example, iCT can be at least a predetermined frangibility limit of the chemically strengthened glass sheet (such as between about 40 MPa and about 48 MPa), and fCT can be less than the predetermined frangibility limit of the glass sheet.

Examples for generating exemplary ion exchangeable glass structures are described in U.S. Patent Application Pub. Nos. 2014/0087193 and 2014/0087159, each of which is incorporated herein by reference in its entirety.

As explained herein, the conditions of the ion exchange step and the annealing step can be adjusted to achieve a desired compressive stress at the glass surface (CS), depth of compressive layer (DOL), and central tension (CT). The ion exchange step can be carried out by immersion of the glass sheet into a molten salt bath for a predetermined period of time, where ions within the glass sheet at or near the surface thereof are exchanged for larger metal ions, for example, from the salt bath. By way of example, the molten salt bath can include KNO₃, the temperature of the molten salt bath can be within the range of about 400° C. to about 500° C., and the predetermined time period can be within the range of about 1 hour to about 24 hours, such as between about 2 hours and about 8 hours. The incorporation of the larger ions into the glass sheet strengthens the glass sheet by creating a compressive stress in a near surface region. A corresponding tensile stress can be induced within a central region of the glass sheet to balance the compressive stress.

By way of further example, sodium ions within the glass sheet can be replaced by potassium ions from the molten salt bath, though other alkali metal ions having a larger atomic radius, such as rubidium or cesium, also can replace smaller alkali metal ions in the glass. In some embodiments, smaller alkali metal ions in the glass sheet can be replaced by Ag+ ions. Similarly, other alkali metal salts such as, but not limited to, sulfates, halides, and the like can be used in the ion exchange process.

The replacement of smaller ions by larger ions at a temperature below that at which the glass network can relax produces a distribution of ions across the surface of the glass sheet resulting in a stress profile. The larger volume of the incoming ion produces a compressive stress (CS) on the surface and tension (central tension, or CT) in the center region of the glass sheet. The compressive stress is related to the central tension by the following approximate relationship:

$$C S = C T ( \frac{t - 2 DOL}{DOL} )$$

where t represents the total thickness of the glass sheet and DOL represents the depth of exchange, also referred to as depth of compressive layer.

A variety of ion exchangeable glass compositions can be employed in producing the chemically strengthened glass sheet. For example, ion exchangeable glass compositions suitable for use in embodiments described herein include alkali aluminosilicate glasses or alkali aluminoborosilicate glasses. As used herein, “ion exchangeable” means that a glass composition is capable of exchanging cations located at or near the surface of the glass sheet with cations of the same valence that are either larger or smaller in size.

For example, a suitable glass composition comprises SiO₂, B₂O₃ and Na₂O, where (SiO₂+B₂O₃) 66 mol. %, and Na₂O 9 mol. %. In some embodiments, the glass sheet includes at least 4 wt. % aluminum oxide or 4 wt. % zirconium oxide. Additionally, or alternatively, a glass sheet includes one or more alkaline earth oxides, such that a content of alkaline earth oxides is at least 5 wt. %. Additionally, or alternatively, a glass sheet comprises at least one of K₂O, MgO, or CaO. In some embodiments, the glass sheet comprises 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In some embodiments, the glass sheet comprises: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; where 12 mol. %≤(Li₂O+Na₂O+K₂O)≤20 mol. % and 0 mol. %≤(MgO+CaO)≤10 mol. %.

In some embodiments, the glass sheet comprises: 63.5-66.5 mol. % SiO₂; 8-12 mol. % Al₂O₃; 0-3 mol. % B₂O₃; 0-5 mol. % Li₂O; 8-18 mol. % Na₂O; 0-5 mol. % K₂O; 1-7 mol. % MgO; 0-2.5 mol. % CaO; 0-3 mol. % ZrO₂; 0.05-0.25 mol. % SnO₂; 0.05-0.5 mol. % CeO₂; less than 50 ppm As₂O₃; and less than 50 ppm Sb₂O₃; where 14 mol. %≤(Li₂O+Na₂O+K₂O)≤18 mol. % and 2 mol. %≤(MgO+CaO)≤7 mol. %.

In some embodiments, an alkali aluminosilicate glass comprises, consists essentially of, or consists of: 61-75 mol. % SiO₂; 7-15 mol. % Al₂O₃; 0-12 mol. % B₂O₃; 9-21 mol. % Na₂O; 0-4 mol. % K₂O; 0-7 mol. % MgO; and 0-3 mol. % CaO.

In some embodiments, an alkali aluminosilicate glass comprises alumina, at least one alkali metal and, in some embodiments, greater than 50 mol. % SiO₂, in other embodiments at least 58 mol. % SiO₂, and in still other embodiments at least 60 mol. % SiO₂, wherein the ratio

$$\frac{{Al}_{2} {O}_{3} + {B}_{2} {O}_{3}}{\sum modifiers} > 1 ,$$

where in the ratio the components are expressed in mol. % and the modifiers are alkali metal oxides. This glass, in particular embodiments, comprises, consists essentially of, or consists of: 58-72 mol. % SiO₂; 9-17 mol. % Al₂O₃; 2-12 mol. % B₂O₃; 8-16 mol. % Na₂O; and 0-4 mol. % K₂O, wherein the ratio

$$\frac{{Al}_{2} {O}_{3} + {B}_{2} {O}_{3}}{\sum modifiers} > 1.$$

In some embodiments, an alkali aluminosilicate glass comprises, consists essentially of, or consists of: 60-70 mol. % SiO₂; 6-14 mol. % Al₂O₃; 0-15 mol. % B₂O₃; 0-15 mol. % Li₂O; 0-20 mol. % Na₂O; 0-10 mol. % K₂O; 0-8 mol. % MgO; 0-10 mol. % CaO; 0-5 mol. % ZrO₂; 0-1 mol. % SnO₂; 0-1 mol. % CeO₂; less than 50 ppm As₂O₃; and less than 50 ppm Sb₂O₃; wherein 12 mol. %≤Li₂O+Na₂O+K₂O≤20 mol. % and 0 mol. %≤MgO+CaO≤10 mol. %.

In some embodiments, an alkali aluminosilicate glass comprises, consists essentially of, or consists of: 64-68 mol. % SiO₂; 12-16 mol. % Na₂O; 8-12 mol. % Al₂O₃; 0-3 mol. % B₂O₃; 2-5 mol. % K₂O; 4-6 mol. % MgO; and 0-5 mol. % CaO, wherein: 66 mol. %≤SiO₂+B₂O₃+CaO≤69 mol. %; Na₂O+K₂O+B₂O₃+MgO+CaO+SrO>10 mol. %; 5 mol. %≤MgO+CaO+SrO≤8 mol. %; (Na₂O+B₂O₃)_Al₂O₃≤2 mol. %; 2 mol. %≤Na₂O≤Al₂O₃≤6 mol. %; and 4 mol. %≤(Na₂O+K₂O)≤Al₂O₃≤10 mol. %.

Additional examples of ion exchangeable glass compositions are described in U.S. Patent Application Pub. Nos. 2014/0087193 and 2014/0087159, each of which is incorporated herein by reference in its entirety.

In some embodiments, the chemically strengthened glass sheet of second pane 14 comprises a thickness of about 0.1 mm to about 2 mm, such as about 0.4 mm, about 0.5 mm, about 0.55 mm, about 0.7 mm, or about 1 mm. Additionally, or alternatively, the chemically strengthened glass sheet comprises a surface CS of about 600 MPa to about 800 MPa, such as about 700 MPa, and/or a DOL of at least about 40 microns. Additionally, or alternatively, the glass sheet comprises a thickness of at most about 1 mm, a residual surface CS of about 500 MPa to about 950 MPa, and/or a DOL of at least about 35 microns.

In some embodiments, one or both surfaces of the glass sheet of second pane 14 can be acid etched to improve durability to external impact events. Acid etching of the surfaces of the glass sheet can reduce the number, size and/or severity of flaws in the surfaces. Surface flaws act as fracture sites in the glass sheet. Reducing the number, the size and severity of the flaws in these surfaces can remove and minimize the size of potential fracture initiation sites in these surfaces to thereby strengthen the surface.

In some embodiments, subjecting the glass sheet to an acid etching process comprises contacting a surface of the glass sheet with an acidic glass etching medium. Such an acid etching process can be versatile, readily tailored to most glasses, and readily applied to both planar and complex 3D geometries. Further, exemplary acid etching has been found to be effective to reduce strength variability, even in glass having a low incidence of surface flaws, including up-drawn or down-drawn (e.g., fusion-drawn) glass sheet that are conventionally thought to be largely free of surface flaws introduced during manufacture or during post-manufacturing processing. In some embodiments, the acid etching process provides a chemical polishing of a glass sheet surface that can alter the size, alter the geometry of surface flaws, and/or reduce the size and number of surface flaws but have a minimal effect on the general topography of the treated surface. In general, acid etching treatments can be employed to remove not more than about 4 μm of surface glass, or in some embodiments not more than 2 μm of surface glass, or not more than 1 μm of surface glass. The acid etch treatment can be performed prior to lamination to protect the respective surface from the creation of any new flaws.

Acid removal of more than a predetermined thickness of surface glass from the chemically strengthened glass sheet should be avoided to ensure that the thickness of the surface compression layer and the level of surface compressive stress provided by that layer are not unacceptably reduced as this could be detrimental to the impact and flexural damage resistance of the glass laminate. Additionally, excessive etching of the glass surface can increase the level of surface haze in the glass to objectionable levels. For window, automotive glazing, and consumer electronics display applications, typically no or very limited visually detectable surface haze in the glass sheet is permitted.

In various embodiments, a variety of etchant chemicals, concentrations, and treatment times can be used to achieve a desirable level of surface treatment and strengthening during the etching process. Exemplary chemicals useful for carrying out the etching process step include fluoride-containing aqueous treating media containing at least one active glass etching compound including, but not limited to, HF, combinations of HF with one or more of HCL, HNO3 and H2SO4, ammonium bifluoride, sodium bifluoride and other suitable compounds. For example, an aqueous acidic solution having 5 vol. % HF (48%) and 5 vol. % H2SO4 (98%) in water can improve the ball drop performance of a chemically strengthened alkali aluminosilicate glass sheet having a thickness in the range of about 0.1 mm to about 1.5 mm using etching times as short as one minute in duration. It should be noted that exemplary glass layers not subjected to chemical strengthening or thermal strengthening, whether before or after acid etching, can require different combinations of etching media to achieve large improvements in ball drop test results.

Maintaining adequate control over the thickness of the glass layer removed by etching in HF-containing solutions can be facilitated if the concentrations of HF and dissolved glass constituents in the solutions are closely controlled. While periodic replacement of the entire etching bath to restore acceptable etching rates is effective for this purpose, bath replacement can be expensive and the cost of effectively treating and disposing of depleted etching solutions can be high. Exemplary methods for etching glass layers is described in co-pending International Patent Application No. PCT/US2013/043561, which is incorporated herein by reference in its entirety.

In some embodiments, the glass sheet of second pane 14 comprises a compressive surface layer having a DOL of at least about 30 μm or at least about 40 μm, after surface etching, and a peak compressive stress level of at least about 500 MPa, or at least about 650 MPa. Etching treatments of limited duration can enable thin alkali aluminosilicate glass sheets offering this combination of properties. In particular, the step of contacting a surface of the glass sheet with an etching medium can be carried out for a period of time not exceeding that required for effective removal of 2 μm of surface glass, or in some embodiments not exceeding that required for effective removal of 1 μm of surface glass. Of course, the actual etching time required to limit glass removal in any particular case can depend upon the composition and temperature of the etching medium as well as the composition of the solution and the glass being treated. However, etching treatments effective to remove not more than about 1 μm or about 2 μm of glass from the surface of a selected glass sheet can be determined by routine experiment.

An alternative method for ensuring that glass sheet strengths and surface compression layer depths are adequate can involve tracking reductions in surface compressive stress level as etching proceeds. Etching time can then be controlled to limit reductions in surface compressive stress necessarily caused by the etching treatment. Thus, in some embodiments the step of contacting a surface of a strengthened alkali aluminosilicate glass sheet with an etching medium can be carried out for a time not exceeding a time effective to reduce the compressive stress level in the glass sheet surface by about 3% or another acceptable amount. Again, the period of time suitable for achieving a predetermined amount of glass removal can depend upon the composition and temperature of the etching medium as well as the composition of the glass sheet, but can also readily be determined by routine experiment. Additional details regarding glass surface acid or etching treatments can be found in U.S. Pat. No. 8,889,254, which is incorporated herein by reference in its entirety.

Additional etching treatments can be localized in nature. For example, surface decorations or masks can be placed on a portion(s) of the glass sheet or article. The glass sheet can then be etched to increase surface compressive stress in the area exposed to the etching while maintaining the original surface compressive stress (e.g., the surface compressive stress of the original ion exchanged glass) in the portion underlying the surface decoration or mask. Of course, the conditions of each process step can be adjusted based on the desired compressive stress at the glass surface, desired depth of compressive layer, and desired central tension.

Concerns related to damage levels of impact injuries to a vehicle occupant have prompted regulations requiring relatively easier breakage for automotive glazing products. For example, in ECE R43 Revision 2, there is a requirement that, when the glass laminate is impacted from an internal object (e.g., by an occupant's head during a collision), the glass laminate should fracture so as to dissipate energy during the event and minimize risk of injury to the occupant. This requirement has restricted direct use of high strength glass sheets as both plies of a glass laminate for automotive glazing applications. Thus, in some embodiments, glass laminate 10 comprises a coated transparent layer on one or more surfaces of first pane 12 and/or second pane 14 to provide a controlled and acceptable breakage strength level for the respective pane and/or the glass laminate. For example, the glass laminate comprises a coated transparent layer (e.g., a porous coating) on the surface of the chemically strengthened glass sheet of second pane 14 adjacent to interlayer 16. During an internal impact event, the acid etched surfaces of the chemically strengthened glass sheet will be in tension, and the presence of a coated transparent layer can trigger breakage of the chemically strengthened glass sheet. An exemplary coated transparent layer or weakening coating can be provided using, for example, a low temperature sol gel process. Exemplary coatings may be transparent with a haze of at most about 10%, an optical transmission at visible wavelengths of at least about 20%, at least about 50%, or at least about 80%, and/or a low birefringence to enable undistorted viewing for users wearing polarized glasses or use in certain transparent display structures.

Although glass laminate 10 is described as having first pane 12 comprising glass-glass laminate structure 100 and second pane 14 comprising a chemically strengthened glass sheet, other embodiments are included in this disclosure. For example, in other embodiments, the second pane comprises a soda lime glass sheet (e.g., with or without chemical strengthening), a thermally strengthened glass sheet, an annealed glass sheet, a glass-glass laminate structure, a polymeric sheet, or another suitable material or structure. In various embodiments, the second pane comprises a thickness of about 0.1 mm to about 3 mm. For example, in some embodiments in which the second pane comprises an annealed glass sheet or a thermally strengthened glass sheet, the second pane comprises a thickness of about 2 mm to about 3 mm, such as about 2.5 mm. The thicknesses of the first pane and the second pane can be the same or different. Exemplary glass sheets can be formed by fusion drawing as described, for example, in U.S. Pat. Nos. 7,666,511, 4,483,700 and 5,674,790, each of which is incorporated herein by reference in its entirety. In some embodiments, the drawn glass is chemically strengthened to form the chemically strengthened glass sheet as described herein. Thus, the glass sheet can comprise a deep DOL of CS, which can enable a high flexural strength, scratch resistance and impact resistance. Exemplary embodiments can also include acid etched or flared surfaces to increase the impact resistance and/or the strength of such surfaces by reducing the size and severity of flaws on the surfaces as described herein.

FIG. 4 is a perspective view of another exemplary embodiment of glass laminate 10. In the embodiment shown in FIG. 4, first pane 12 is configured as an outer layer of glass laminate 10, and second pane 14 is configured as an inner layer of the glass laminate. In other embodiments, the first pane can be configured as the inner layer and the second pane can be configured as the outer layer. Thus, the outer layer, the inner layer, or both the outer layer and the inner layer can comprise a glass-glass laminate structure as described herein. In some embodiments, the chemically strengthened glass sheet of second pane 14 comprises a thickness of less than or equal to 1 mm, a residual surface CS of about 500 MPa to about 950 MPa, and/or a DOL of at least about 35 microns. In the embodiment shown in FIG. 4, glass laminate 10 comprises a curved 3D shape. In other embodiments, the glass laminate can be formed into a variety of different 3D shapes, which can be tailored to specific applications. In some embodiments, glass laminate 10 is formed into a 3D shape by bending the glass laminate (e.g., into a windshield a console or other configuration for use in a vehicle). Glass laminate 10 can comprise one or more acid etched or weakened surfaces as described herein.

In some embodiments, glass laminate 10 having a 3D shape can be formed using a cold forming process. For example, glass-glass laminate structure 100 of first pane 12 can be formed into the 3D shape using a suitable molding process, such as, for example, a ring molding process, a press molding process, a vacuum molding process, or another suitable molding process. The strengthened glass sheet of second pane 12 can be cold formed to first pane 12 comprising the 3D shape. In an exemplary cold forming process, the chemically strengthened glass sheet can be laminated to the shaped or curved first pane 12. Such a cold forming process can reduce the CS at the surface of the chemically strengthened glass sheet adjacent to interlayer 16, which can render the chemically strengthened glass sheet more prone to fracturing in response to impact by an object (e.g., an internal impact by an occupant of a vehicle). Additionally, or alternatively, such a cold forming process can provide a high CS on an opposing surface of the chemically strengthened glass sheet remote from interlayer 16, which can make this surface more resistant to fracture from abrasion. In some embodiments, an exemplary cold forming process can be performed at or just above the softening temperature of the interlayer material (e.g., about 100° C. to about 120° C.), that is, at a temperature less than the softening temperature of the respective panes of the glass laminate. Such a cold forming process can be performed using a vacuum bag or ring in an autoclave or another suitable apparatus.

In some embodiments, glass laminate 10 having a 3D shape can be formed by shaping first pane 12 and second pane 14 into the 3D shape prior to lamination, and then laminating the shaped first pane and second pane to each other with interlayer 16. Such a forming process can be suitable for glass laminates comprising two glass-glass laminate structures laminated to each other with the interlayer therebetween. Large thin glass sheets can be shaped in a lehr comprising a plurality of furnaces arranged in series in which the temperature of the glass sheet is gradually raised to accomplish sagging under gravity. However, the temperature differential to achieve the desired shape for thin glass sheets may not be accomplished with simple variable heating in the furnace due to radiation view factors from the hot and cold zones of the furnace walls to both the center and edges of the glass sheet. Blocking radiation, e.g., radiation from the hot furnace zone to the glass sheet edges and from the cold furnace zone to the center of the glass sheet) can help to achieve the desired temperature differential. In some embodiments, a system for shaping a glass sheet comprises a shaping mold, a heating source (e.g., a radiation source), and a shield (e.g., a radiation shield). The shield can be positioned substantially between the heating source and the glass sheet. Additionally, or alternatively, the shield comprises an outer wall defining a cavity having a first opening disposed to face the glass sheet and a second opening disposed to face the heating source. In some embodiments, the heating source comprises a plurality of radiant heating elements. The shield can be supported by and attached to the shaping mold or a furnace. The outer wall of the shield can form a cavity having any cross-sectional shape (e.g., circular, ovoid, triangular, square, rectangular, rhomboid, or polygonal). In some embodiments, the shield comprises a plurality of shields. For example, a second radiation shield comprising an inner wall defining a second cavity can be disposed concentrically within the cavity defined by the outer wall of the first radiation shield.

In some embodiments, a method for shaping a glass sheet comprises positioning the glass sheet on a shaping mold, introducing the shaping mold and glass sheet into a furnace comprising a heating source (e.g., a radiation heating source), and heating the glass sheet. A shield (e.g., a radiation shield) can be positioned substantially between the glass sheet and the heating source. The shield can comprise an outer wall defining a cavity having a first opening disposed to face the glass sheet and a second opening disposed to face the heating source. In some embodiments, the method comprises heating the glass sheet to a temperature of about 400° C. to about 1000° C. with a residence time of about 1 minute to about 60 minutes or more.

In some embodiments, first pane 12 comprises glass-glass laminate structure 100, and second pane 14 comprises a strengthened glass sheet. The strengthened glass sheet can be thermally strengthened, chemically strengthened, or mechanically strengthened (e.g., a second glass-glass laminate structure). An inner surface of first pane 12 adjacent to interlayer 16 and/or an outer surface of second pane 14 remote from the interlayer can be chemically polished. It should be noted that the terms “inner surface” and “outer surface” refer to the position of the surface relative to the interlayer and do not imply that the surface forms an exterior or interior surface, for example, of a vehicle or a building. The chemically polished surfaces can be acid etched. Additionally, or alternatively, an inner surface of second pane 14 adjacent to interlayer 16 can comprise a substantially transparent coating formed thereon. In some embodiments, one or both surfaces of first pane 12 and/or second pane 14 comprise a surface CS of about 500 MPa to about 950 MPa and/or a DOL of about 30 μm to about 50 μm. In some embodiments, the inner surface of first pane 12 and/or the outer surface of second pane 14 have a higher surface CS than the outer surface of the first pane and/or the inner surface of the second pane. Additionally, or alternatively, the inner surface of first pane 12 and/or the outer surface of second pane 14 have a lower DOL than the outer surface of the first pane and/or the inner surface of the second pane. Exemplary thicknesses of the first pane and the second pane can be, but are not limited to, a thickness of at most about 1.5 mm, at most about 1 mm, at most about 0.7 mm, at most about 0.5 mm, about 0.5 mm to about 1 mm, or about 0.5 mm to about 0.7 mm. Of course, the thicknesses, compositions, and/or structures of the first and second panes can be different.

In some embodiments, the substantially transparent coating contributes to a reduced surface CS of one or more surfaces of the chemically strengthened glass sheet. For example, the substantially transparent coating can comprise a porous sol-gel coating that is coated or disposed on one or more surfaces of the glass sheet prior to ion-exchange. The porosity of the coating can enable ion-exchange through the coating, but in such a way that the diffusion of ions into the glass sheet is partially inhibited by the coating. This can lead to a lower CS and/or lower DOL on the coated surface of the chemically strengthened glass sheet, relative to a non-coated surface. The coating can have a determined porosity to provide a determined CS at the coated surface of the chemically strengthened glass sheet. A significant imbalance of the compressive stress between the two opposing surfaces of the chemically strengthened glass sheet can result in some bowing of the glass sheet. Such bowing can aid in cold forming the chemically strengthened glass sheet of the second pane to the first pane as described herein. In some embodiments, the ion exchange induced bowing is slightly less than the amount of bowing or bending desired in the final laminate after cold forming. In some embodiments in which the transparent coating is applied before ion-exchange, the temperature of processing or curing the transparent coating can be higher than in other embodiments, for example as high as 500° C. or 600° C.

In some embodiments, a method of forming a glass laminate comprises strengthening one or both of a first pane and a second pane and laminating the first pane and the second pane to each other using a polymer interlayer intermediate the first pane and the second pane. At least the first pane comprises a glass-glass laminate structure. In some embodiments, the method comprises chemically polishing (e.g., acid etching) an inner surface of the first pane adjacent to the interlayer, chemically polishing an outer surface of the second pane remote from the interlayer, and/or forming a substantially transparent coating on an inner surface of the second pane adjacent to the interlayer. In some embodiments, the method comprises strengthening (e.g., chemically strengthening, thermally strengthening, or mechanically strengthening) the second pane. Additionally, or alternatively, chemically polishing a surface of the first pane or the second pane comprises acid etching the surface to remove at most about 4 μm, at most about 2 μm, or at most about 1 μm of the pane. The chemically polishing can be performed prior to laminating the first pane and the second pane. In some embodiments, chemically polishing a surface of the first pane or the second pane comprises etching the surface to provide surface CS of about 500 MPa to about 950 MPa at the surface and/or a DOL of about 30 μm to about 50 μm from the surface. In some embodiments, forming a substantially transparent coating comprises coating a surface using a sol gel process at a temperature of at most about 400° C. or at most about 350° C.

In some embodiments, a method for cold forming a glass laminate comprises laminating a curved first pane and a substantially planar second pane together with a polymer interlayer intermediate the first pane and the second at a temperature less than the softening temperature of each of the first pane and the second pane. The first pane comprises a glass-glass laminate structure. In some embodiments, the second pane comprises a glass sheet, such as a thermally strengthened, chemically strengthened, and/or mechanically strengthened glass sheet. After laminating, the second pane comprises a substantially similar curvature to that of the first pane. In some embodiments, after laminating, the second pane comprises a difference in surface compressive stresses on opposing first and second surfaces of the glass sheet.

In some embodiments, one or more panes of the glass laminate comprises a material that is configured to absorb electromagnetic radiation over a particular range of wavelengths. For example, one or more layers of the glass-glass laminate structure comprises an absorptive or tinted glass material. The absorptive glass material can be configured to absorb radiation, for example, in the infrared (IR) wavelength range (e.g., about 750 nm to about 1 mm), in the ultraviolet (UV) wavelength range (e.g., about 100 nm to about 400 nm), in the visible wavelength range (e.g., about 380 nm to about 760 nm), another suitable wavelength range, or combinations thereof. In other embodiments, any of the glass sheets described herein for use as a pane of the glass laminate can comprise an absorptive glass material. Additionally, or alternatively, any of the polymer sheets described herein for use as a pane of the glass laminate and/or the interlayer can comprise an absorptive polymeric material. Additionally, or alternatively, an interlayer as described herein comprises an absorptive material. In some embodiments, one or more panes of the glass laminate comprises a material with a low emissivity (low E). For example, one or more layers of the glass-glass laminate structure, a glass sheet, a polymer sheet, and/or an interlayer comprises a low E material. In automotive or architectural applications, such absorptive or low E materials can help to protect the interior of the automobile or building from excessive heat or damage caused by exposure to a particular wavelength of radiation. In display applications, such absorptive or low E materials can help to protect materials within the display from damage caused by exposure to a particular wavelength of radiation (e.g., UV radiation). In some embodiments, absorption or tinting is provided by an absorptive coating or an absorptive film disposed on a surface of the glass laminate.

In some embodiments, the glass laminate comprises a transparent display. For example, one or more panes of the glass laminate comprises light scattering features such that an image can be projected onto the glass laminate for viewing by a viewer. Additionally, or alternatively, one or more panes of the glass laminate comprises light emitting elements (e.g., an LED, a microLED, an OLED, a plasma cell, an electroluminescent (EL) cell) configured to generate a display image for viewing by a viewer. In some embodiments, the glass-glass laminate structure comprises the light scattering features or light emitting elements in one or more layers thereof (e.g., the core layer, the first cladding layer, and/or the second cladding layer). In some examples, the transparent display is at least partially transparent to visible light. Ambient light (e.g., sunlight) may make the display image difficult or impossible to see when projected on and/or generated by such a display surface. In some embodiments, the transparent display, or portion thereof on which the display image is projected or from which the display image is generated, can include a darkening material such as, for example, an inorganic or organic photochromic or electrochromic material, a suspended particle device, and/or a polymer dispersed liquid crystal. Thus, the transparency of the transparent display can be adjusted to increase the contrast of the display image. For example, the transparency of the transparent display can be reduced in bright sunlight by darkening the display to increase the contrast of the display image. The adjustment can be controlled automatically (e.g., in response to exposure of the transparent display to a particular wavelength of light, such as ultraviolet light, or in response to a signal generated by a light detector, such as a photoeye) or manually (e.g., by a viewer).

In some embodiments, one or more panes of the glass laminate comprises a darkening material such as, for example, an inorganic or organic photochromic or electrochromic material, a suspended particle device, and/or a polymer dispersed liquid crystal. Thus, the transparency of the glass laminate can be adjusted. In glazing applications (e.g., automotive or architectural glazing applications), the transparency of the glass laminate can be adjusted to increase or decrease the amount of ambient light (e.g., sunlight) allowed to pass through the glass laminate. In display applications (e.g., transparent display applications), the transparency of the glass laminate can be adjusted to increase the contrast of a display image projected on or generated from the glass laminate. For example, the transparency of the glass laminate can be reduced in bright sunlight by darkening the glass laminate to increase the contrast of the display image. In various embodiments, the adjustment can be controlled automatically (e.g., in response to exposure of the glass laminate to a particular wavelength of light, such as ultraviolet light, or in response to a signal generated by a light detector, such as a photoeye) or manually (e.g., by a passenger).

Various embodiments described herein can enable light weight glass laminates with superior performance in external impact resistance compared to conventional glass laminates and controlled breakage behavior upon internal impact (e.g., for vehicular applications).

The glass-glass laminate structures and/or glass laminates described herein can be suitable for a range of applications. One application of particular interest can be, but is not limited to, automotive glazing applications (e.g., a windshield, a sidelite, a sun roof, a moon roof, or a backlite), whereby the glass-glass laminate and/or glass laminate can pass automotive impact safety standards. Another application can be, but is not limited to, automotive consoles, dashboards, door panels, lamp covers, instrument covers, mirrors, or interior or exterior panels (e.g., for a pillar or other applique). Another application can be, but is not limited to, decorative panels or coverings (e.g., for walls, columns, elevator cabs, kitchen appliances, or other applications). Other applications can be identified by those knowledgeable in the art.

Another application of interest for the glass-glass laminate structures and/or glass laminates described herein can be, but is not limited to, display (e.g., cover glass or glass backplane) and/or touch panel applications, whereby the glass-glass laminate and/or glass laminate can enable a display and/or touch panel with desired attributes of the glass laminate such as curved shape, mechanical strength, etc. Such displays and/or touch panels can be suitable for use in automotive or vehicular applications.

In various embodiments, the glass-glass laminate structures and/or glass laminates described herein can be incorporated into vehicles such as automobiles, boats, and airplanes (e.g., glazing such as windshields, windows or sidelites, mirrors, pillars, side panels of a door, headrests, dashboards, consoles, or seats of the vehicle, or any portions thereof), architectural fixtures or structures (e.g., internal or external walls of building, and flooring), appliances (e.g., a refrigerator, an oven, a stove, a washer, a dryer, or another appliance), consumer electronics (e.g., televisions, laptops, computer monitors, and handheld electronics such as mobile phones, tablets, and music players), furniture, information kiosks, retail kiosks, and the like.

The glass-glass laminate structures and/or glass laminates described herein can be used for a variety of applications including, for example, for cover glass or glass backplane applications in consumer or commercial electronic devices including, for example, LCD, LED, microLED, OLED, quantum dot, plasma, and electroluminescent (EL) displays, computer monitors, and automated teller machines (ATMs); for touch screen or touch sensor applications, for portable electronic devices including, for example, mobile telephones, personal media players, and tablet computers; for integrated circuit applications including, for example, semiconductor wafers; for photovoltaic applications; for architectural glass applications; for automotive or vehicular glass applications including, for example, glazing and displays; for commercial or household appliance applications; for lighting or signage (e.g., static or dynamic signage) applications; or for transportation applications including, for example, rail and aerospace applications.

### EXAMPLES

Various embodiments will be further clarified by the following examples.

### Example 1

A glass laminate similar to that shown in FIG. 1 was formed. The first pane was a glass-glass laminate structure with a thickness of about 1 mm. The ratio of the core layer thickness to the cladding layer thickness (the sum of the thicknesses of both cladding layers) was about 6. The compressive stress of the cladding layers was about 150 MPa, and the central tension of the core layer was about 25 MPa. The interlayer was formed from PVB and had a thickness of about 0.8 mm. The second pane was a chemically strengthened glass sheet with a thickness of about 0.4 mm.

The glass laminate was positioned at an angle of about 30° from vertical, and the first pane of the glass laminate was struck with 12 oz of SAE G699 gravel dropped a few pieces at a time from a height of about 6 ft. 8 out of 8 samples of the glass laminate that were tested survived the impact.

### Example 2

A glass laminate similar to that shown in FIG. 1 was formed. The first pane was a glass-glass laminate structure with a thickness of about 1 mm. The ratio of the core layer thickness to the cladding layer thickness (the sum of the thicknesses of both cladding layers) was about 9. The compressive stress of the cladding layers was about 190 MPa, and the central tension of the core layer was about 21 MPa. The interlayer was formed from PVB and had a thickness of about 0.8 mm. The second pane was a chemically strengthened glass sheet with a thickness of about 0.4 mm.

The glass laminate was positioned at an angle of about 30° from vertical, and the first pane of the glass laminate was struck with 12 oz of SAE G699 gravel dropped a few pieces at a time from a height of about 6 ft. 8 out of 8 samples of the glass laminate that were tested survived the impact.

### Example 3

A glass laminate is formed. The first pane is a glass-glass laminate structure with a thickness of about 1 mm. The interlayer is formed from PVB and has a thickness of about 0.8 mm. The second pane is a second glass-glass laminate structure with a thickness of about 0.5 mm.

### Example 4

Glass laminates similar to that shown in FIG. 1 were formed. The first pane was a glass-glass laminate structure, or mechanically strengthened glass sheet, with varying properties among Examples 4A-4D as shown in Table 2. In each of Examples 4A-4D, the second pane was a chemically strengthened glass sheet with a thickness of 0.7 mm, a CS of about 700 MPa, and a DOL of 45 μm (as measured by FSM). The interlayer was adhesive tape disposed between the first and second panes.

TABLE 2
Examples 4A-4D
Mechanically Strengthened Glass Substrate Attributes

| | Thickness | CS | DOL | CT | Surviving |
|---|---|---|---|---|---|
| Ex. | (mm) | (MPa) | (μm) | (MPa) | (out of 10) |
| 4A | 1 | 150 | 71 | 25 | 10 |
| 4B | 1 | 190 | 50 | 21 | 10 |
| 4C | 0.7 | 190 | 50 | 31.67 | 10 |
| 4D | 0.7 | 180 | 70 | 45 | 9 |

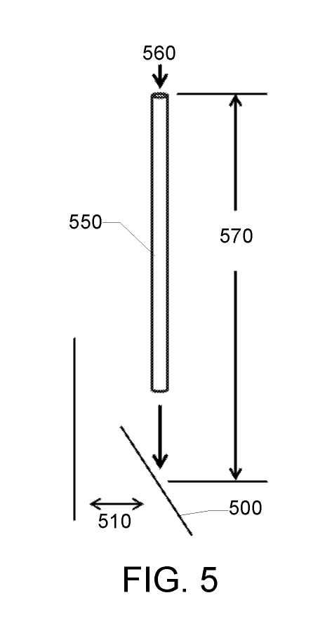

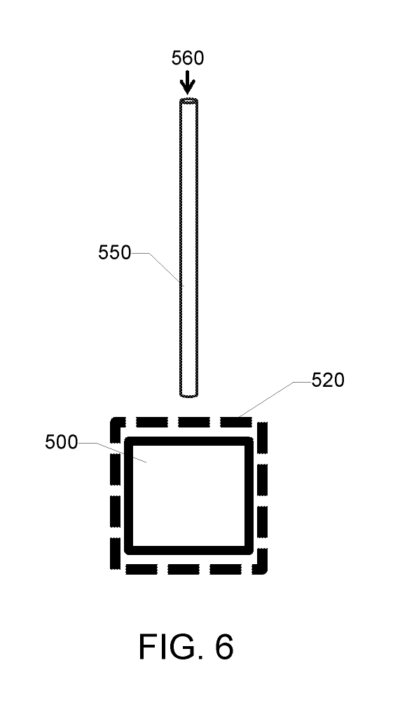

Ten samples of each of Examples 4A-4D were subjected to the following Stone Impact Test. Referring to FIGS. 5-6, each sample 500 was positioned at 30 degrees from normal 510 (as specifically shown in FIG. 5), with the mechanically strengthened glass sheet facing toward tube 550. Each sample was supported by a polyvinyl chloride frame 520 including a neoprene insert having a 70 duro hardness, 1 inch width and ⅛ inch thickness, as shown in FIG. 6. After each sample was positioned in the frame in this manner, 12 ounces of SAE G699 grade gravel 560 was poured a few pieces at a time through tube 550 made of Plexiglass® suspended over sample 500. The gravel impacted the surface of the mechanically strengthened glass sheet from a drop height 570 (i.e., the distance between gravel 560 and the top surface of the mechanically strengthened glass substrate was 6 feet). The number of samples (out of the ten samples tested for each of Examples 4A-4D) that survived by not fracturing or breaking is shown in Table 2.

After the samples of Examples 4A-4D were subjected to the Stone Impact Test, the mechanically strengthened glass sheets were separated from the chemically strengthened sheet and adhesive tape, and individually subjected to ring-on-ring load to failure testing according to ASTM C1499 “Standard Test Method for Monotonic Equibiaxial Flexural Strength of Advanced Ceramics at Ambient Temperature” to demonstrate the retention of average flexural strength of the mechanically strengthened glass sheet. The ring-on-ring load to failure testing parameters included a contact radius of 1.6 mm, a cross-head speed of 1.2 mm/minute, a load ring diameter of 0.5 inches, and a support ring diameter of 1 inch. The surface of the mechanically strengthened glass sheet that had been impacted by the gravel was placed in tension. Before testing, an adhesive film was placed on both sides of the sheet being tested to contain broken glass shards.

Comparative Examples 4E-4H each included annealed or heat strengthened soda lime silicate glass sheets having the thicknesses shown in Table 3. Ten samples each of Comparative Examples 4E-4H were subjected to the same Stone Impact Test as Examples 4A-4D. The ten samples each of Comparative Examples 4E-4H were also then subjected to ring-on-ring testing in the same manner as the mechanically strengthened sheets of Examples 4A-4D.

TABLE 3
Comparative Examples 4E-4H

| Comparative | | Thickness |
|---|---|---|
| Ex. | Type | (mm) |
| 4E | Annealed | 2.1 |
| 4F | Heat strengthened | 1.8 |
| 4G | Heat strengthened | 2.1 |
| 4H | Heat strengthened | 2.3 |

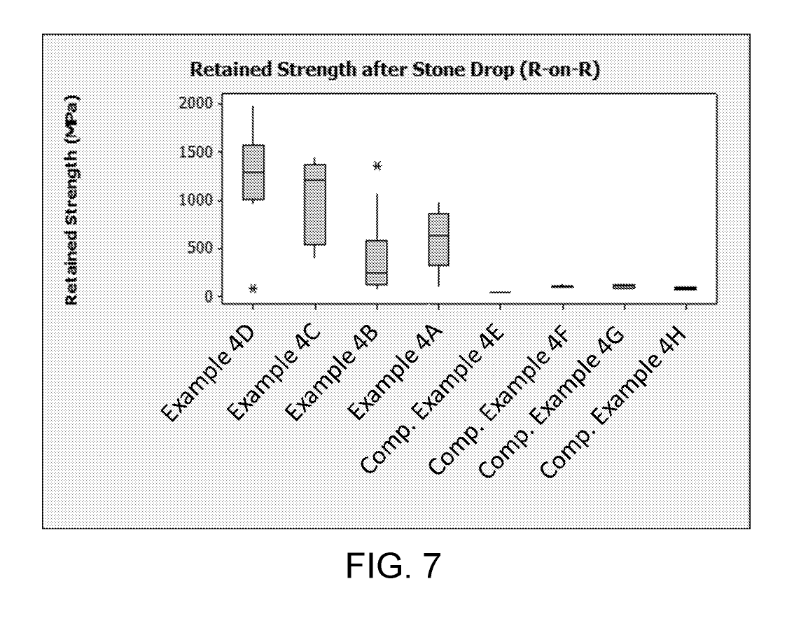

The retained strength results are shown in FIG. 7, which show that even when much thinner mechanically strengthened glass sheets were damaged under the Stone Impact Test, such sheets exhibited significantly higher load to failure values than much thicker soda lime silicate glass sheets damaged in the same manner (i.e., by the Stone Impact Test). Specifically, the mechanically strengthened sheets of Examples 4C and 4D, having a CT of 30 MPa or greater, exhibited significantly greater load to failure than Comparative Examples 4E-4H.

Without being bound by theory, it is believed that laminates including the mechanically strengthened panes as described herein exhibit improved survival in the Stone Impact Test due to the strength of individual panes, even when such panes have a thickness of about 1 mm or less (e.g., 0.7 mm). It is also believed that the survival improves when combined with a strengthened glass pane.

The retained strength of Comparative Example 4E was compared to the retained strength of a 6 mm-thick chemically strengthened soda lime glass substrate (Comparative Example 41) and a 2 mm-thick mechanically strengthened glass substrate (Example 4J). Comparative Examples 4E and 41 and Example 4J were subjected to the Stone Impact Test (as single substrates) prior to being tested by ring-on-ring testing. Both the Stone Impact Test and the ring-on-ring load to failure test were conducted in the same manner as Examples 4A-4D.

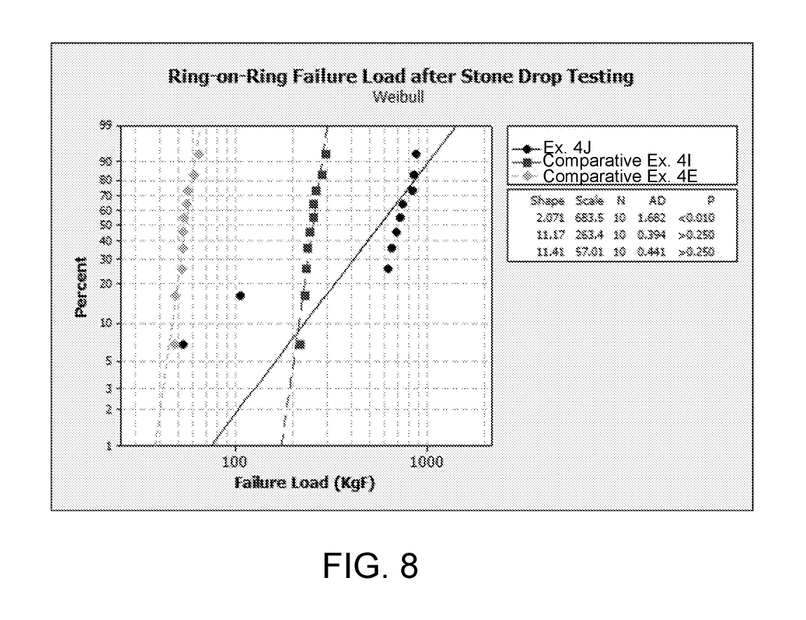

FIG. 8 shows the respective retained strength for Comparative Example 4E, Comparative Example 41 and Example 4J. As shown in FIG. 8, Example 4J exhibited significantly greater load to failure than Comparative Example 4E (which had a comparable thickness to Example 4J) and Comparative Example 41 (which had thickness three times the thickness of Example 4J).

It will be apparent to those skilled in the art that various modifications and variations can be made without departing from the spirit or scope of the invention. Accordingly, the invention is not to be restricted except in light of the attached claims and their equivalents.

What is claimed is:

1. A glass laminate comprising:
a first pane comprising a glass-glass laminate structure;
a second pane; and
an interlayer disposed between the first pane and the second pane and comprising a polymeric material.

2. The glass laminate of claim 1, wherein the glass-glass laminate structure comprises a thickness of about 0.5 mm to about 3 mm.

3. The glass laminate of claim 1, wherein the glass-glass laminate structure comprises an effective 10^{9.9} P temperature of at most about 750° C.

4. The glass laminate of claim 1, wherein the glass-glass laminate structure comprises a first glass layer and a second glass layer fused to the first glass layer.

5. The glass laminate of claim 4, wherein the first glass layer comprises a core layer, the second glass layer comprises a first cladding layer and a second cladding layer, and the core layer is disposed between the first cladding layer and the second cladding layer.

6. The glass laminate of claim 4, wherein the second glass layer comprises a compressive stress of about 10 MPa to about 800 MPa.

7. The glass laminate of claim 1, wherein the second pane comprises a second glass-glass laminate structure.

8. The glass laminate of claim 1, wherein the second pane comprises a chemically strengthened glass sheet, wherein the chemically strengthened glass sheet comprises a thickness of about 0.1 mm to about 2 mm.

9-11. (canceled)

12. The glass laminate of claim 8, wherein the chemically strengthened glass sheet comprises an inner surface adjacent to the interlayer, a surface compressive stress at the inner surface of about 500 MPa to about 950 MPa, and a depth of compressive layer at the inner surface of about 30 μm to about 50 μm.

13. (canceled)

14. The glass laminate of claim 1, wherein the second pane comprises a glass sheet.

15. (canceled)

16. The glass laminate of claim 1, wherein the polymeric material is selected from the group consisting of poly vinyl butyral (PVB), polycarbonate, acoustic PVB, ethylene vinyl acetate (EVA), thermoplastic polyurethane (TPU), ionomer, ionoplast, a cast in place (CIP) resin, a thermoplastic material, and combinations thereof.

17. The glass laminate of claim 1, wherein at least one of:
a. a degradation rate of the first pane in response to exposure to a 5 vol % aqueous HCl solution at 95° C. for 6 h determined using a durability test is at most about 0.018 mg/cm²; or
b. a degradation rate of the first pane in response to exposure to a 1 M aqueous HNO₃ solution at 95° C. for 24 h determined using the durability test is at most about 0.08 mg/cm²; or
c. a degradation rate of the first pane in response to exposure to a 0.02 N aqueous H₂SO₄ solution at 95° C. for 24 h determined using the durability test is at most about 0.04 mg/cm².

18. The glass laminate of claim 1, comprising a retained strength of at least about 200 MPa after being subjected to a stone impact test in which the first pane comprises a thickness of 0.7 mm; the second pane comprises a chemically strengthened glass sheet with a thickness of 0.7 mm, a CS of about 700 MPa, and a DOL of about 45 μm; and the interlayer comprises an adhesive tape.

19-21. (canceled)

22. An automotive glazing comprising the glass laminate of claim 1.

23. A vehicle comprising the glass laminate of claim 1.

24. An architectural panel comprising the glass laminate of claim 1.

25. A method of forming the glass laminate comprising a first pane that comprises a glass-glass laminate structure; a second pane; and an interlayer that is disposed between the first pane and the second pane and comprises a polymeric material, the method comprising:
laminating the first pane to the second pane with the interlayer to form the glass laminate.

26. The method of claim 25, wherein:
the laminating comprises a cold forming process comprising laminating the first pane in a curved state to the second pane in a substantially planar state at a temperature that is less than a softening temperature of the first pane and a softening temperature of the second pane; and
after the laminating, the glass laminate is in a curved state.

27. A glass-glass laminate structure comprising:
a core layer;
a first cladding layer adjacent to the core layer and a second cladding layer adjacent to the core layer, the core layer disposed between the first cladding layer and the second cladding layer; and
a pattern formed on a surface of the glass-glass laminate structure and comprising an inorganic ink or enamel;
wherein each of the first cladding layer and the second cladding layer comprises a compressive stress of about 10 MPa to about 800 MPa.

28-30. (canceled)
